(19) United States
(12) Patent Application Publication
(10) Pub. No.: US 2026/0331518 A1
(43) Pub. Date: Oct. 22, 2026

(54) CATHODE COMPOSITE MATERIAL AND BATTERY

(71) Applicant: TOYOTA JIDOSHA KABUSHIKI KAISHA, Toyota-shi (JP)

(72) Inventor: Hideaki WATANABE, Nisshin-shi (JP)

(73) Assignee: TOYOTA JIDOSHA KABUSHIKI KAISHA, Toyota-shi (JP)

(21) Appl. No.: 19/533,505

(22) Filed: Feb. 9, 2026

(30) Foreign Application Priority Data
Apr. 22, 2025 (JP) 2025-070508

(51) Int. Cl. H01M 4/62; C09J 127/16; H01M 4/02; H01M 4/131; H01M 10/0525

(52) U.S. Cl. CPC H01M 4/628; C09J 127/16; H01M 4/131; H01M 4/623; H01M 10/0525; H01M 2004/021; H01M 2004/028

(57) ABSTRACT

The present disclosure addresses the issue described above by providing a cathode composite material containing a cathode active material, a sulfide solid electrolyte, and a binder, in which: the sulfide solid electrolyte has an LGPS crystalline phase; and a weight average molecular weight of the binder is 500,000 or more.

### CROSS-REFERENCE TO RELATED APPLICATION

This application claims priority to Japanese Patent Application No. 2025-070508 filed on Apr. 22, 2025. The disclosure of the above-identified application, including the specification, drawings, and claims, is incorporated by reference herein in its entirety.

### BACKGROUND

### 1. Technical Field

The present disclosure relates to a cathode composite material and a battery.

### 2. Description of Related Art

A battery includes an electrolyte layer containing a solid electrolyte between a cathode layer and an anode layer. The cathode layer contains at least a cathode active material, and may further contain a solid electrolyte that improves ionic conductivity and a conductive material that improves electronic conductivity.

For example, Japanese Unexamined Patent Application Publication No. 2024-008062 (JP 2024-008062 A) discloses a sulfide solid electrolyte having an LGPS crystalline phase, and a solid-state battery containing the sulfide solid electrolyte.

### SUMMARY

From the viewpoint of improving battery performance, there is a demand to reduce battery resistance. The present disclosure has been made in view of the above circumstances, and has a main object to provide a cathode composite material that can reduce battery resistance.

[1] A cathode composite material containing a cathode active material, a sulfide solid electrolyte, and a binder, in which:
the sulfide solid electrolyte has an LGPS crystalline phase; and
a weight average molecular weight of the binder is 500,000 or more.

[2] The cathode composite material according to [1], in which the weight average molecular weight is 1,000,000 or more.

[3] The cathode composite material according to [1] or [2], in which the weight average molecular weight is 1,500,000 or less.

[4] The cathode composite material according to any one of [1] to [3], in which a particle size D₉₀ of the sulfide solid electrolyte is 1.6 μm or more and 58.0 μm or less.

[5] The cathode composite material according to any one of [1] to [4], in which the binder is a chained fluorine-containing binder.

[6] A battery including a cathode layer, an anode layer, and a solid electrolyte layer disposed between the cathode layer and the anode layer, in which the cathode layer contains the cathode composite material according to any one of [1] to [5].

The present disclosure has an effect of providing the cathode composite material that can reduce battery resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view illustrating a battery according to the present disclosure.

### DETAILED DESCRIPTION OF EMBODIMENTS

A cathode composite material and a battery according to the present disclosure will be described in detail below. Each drawing shown below is a schematic drawing, and the size and shape of each part are exaggerated as appropriate to facilitate understanding. In the present disclosure, the weight average molecular weight of a binder may be simply referred to as “molecular weight.” In the present disclosure, a sulfide solid electrolyte having an LGPS crystalline phase may be simply referred to as “LGPS sulfide solid electrolyte” or “sulfide solid electrolyte.”

### A. Cathode Composite Material

The cathode composite material in the present disclosure contains a cathode active material, a sulfide solid electrolyte, and a binder, and the sulfide solid electrolyte has an LGPS crystalline phase. The weight average molecular weight of the binder is 500,000 or more.

According to the present disclosure, the cathode composite material contains the binder having the weight average molecular weight of 500,000 or more, and can therefore reduce battery resistance.

LGPS sulfide solid electrolytes are known to have good ionic conductivity. The LGPS sulfide solid electrolytes have high crystallinity and have a small amount of polar functional groups on the surfaces. Therefore, it is presumed that the sulfide solid electrolytes have low affinity with components in the cathode composite material, such as a dispersion medium and a cathode active material, and agglomeration (re-agglomeration) is likely to occur between the sulfide solid electrolytes. As a result, it is presumed that coarse sulfide solid electrolytes may be formed in the cathode composite material and the cathode layer containing the cathode composite material, or the sulfide solid electrolytes may be distributed unevenly, resulting in a decrease in battery resistance. In the present disclosure, the binder having the weight average molecular weight of 500,000 or more is contained, and therefore the agglomeration of the sulfide solid electrolytes can be suppressed. This is presumably because binders having large molecular weights and attached to the surfaces of the sulfide solid electrolytes repel each other sterically. As a result, it is presumed that the unevenness in the sulfide solid electrolytes in the cathode composite material and the cathode layer is suppressed, the contact area between the cathode active material and the sulfide solid electrolytes is increased, and the decrease in battery resistance can be suppressed.

### 1. Binder

The weight average molecular weight of the binder in the present disclosure is 500,000 or more. When the molecular weight is less than 500,000, the steric repulsion between the binders is small, and the agglomeration of the sulfide solid electrolytes cannot be suppressed. The weight average molecular weight of the binder may be 600,000 or more, 700,000 or more, 800,000 or more, 900,000 or more, or 1,000,000 or more. The weight average molecular weight is, for example, 1,500,000 or less, and may be 1,200,000 or less, 1,100,000 or less, or 1,000,000 or less. The weight average molecular weight can be measured, for example, by liquid chromatography mass spectrometry (LC/MS), gel permeation chromatography (GPC), or light scattering. The binder contained in the cathode composite material and the cathode layer can be isolated, for example, by immersing them in a solvent and extracting the binder.

The shape of the binder is not particularly limited, but may be a chained or spherical shape, and the former is preferable. This is presumably because the chained binder is entangled with the surfaces of the sulfide solid electrolytes to further suppress the contact between the sulfide solid electrolytes. It is also presumed that the chained binder has a greater steric repulsion than the spherical binder, and can further suppress the agglomeration of the sulfide solid electrolytes. The major axis of the binder measured by microscopic observation is represented by A, the minor axis is represented by B, and A/B represents the aspect ratio of the binder. For example, when the aspect ratio (A/B) is 5 or more, determination can be made that the binder has a chained shape. When the type of the binder described later is the same, the shape is more likely to be a spherical shape as the weight average molecular weight increases.

The cathode composite material may contain only the chained binder, or may contain both the chained binder and the spherical binder. In the latter case, the proportion of the chained binder is preferably large. The proportion of the chained binder to the total binder is, for example, 80 wt % or more, and may be 90 wt % or more, or 99 wt % or more.

Examples of the binder include rubber-based binders and fluorine-based binders (fluorine-containing binders). Examples of the rubber-based binders include butadiene rubber (BR) and styrene butadiene rubber (SBR). Examples of the fluorine-containing binders include polyvinylidene fluoride (PVDF). Whether the binder contains fluorine can be determined by, for example, EDX analysis.

The proportion of the binder in the cathode composite material (solid content) is not particularly limited, but is, for example, 0.1 wt % or more and 5 wt % or less. In the cathode composite material, the proportion of the binder to the cathode active material is, for example, 0.3 wt % or more and 10 wt % or less.

### 2. Sulfide Solid Electrolyte

The sulfide solid electrolyte in the present disclosure has the LGPS crystalline phase. The sulfide solid electrolyte having the LGPS crystalline phase has relatively high ionic conductivity.

The presence of the LGPS crystalline phase in the sulfide solid electrolyte can be determined by, for example, X-ray diffraction measurement (XRD measurement) using CuKα radiation. The LGPS crystalline phase may have a peak observed at a predetermined position in the X-ray diffraction measurement using CuKα radiation. Examples of peak positions of the LGPS crystalline phase include 20=17.38°, 20.18°, 20.44°, 23.56°, 23.96°, 24.93°, 26.96°, 29.07°, 29.58°, 31.71°, 32.66°, and 33.39°. In particular, the LGPS crystalline phase has characteristic peaks at 20=20.18°, 20.44°, 26.96°, and 29.58°. The peak position may vary slightly, for example, due to slight changes in the crystal lattice depending on the material composition. The peak position may vary within a range of ±0.50°, ±0.30°, or ±0.10°.

The sulfide solid electrolyte in the present disclosure may be a single-phase material of the LGPS crystalline phase, or may be a mixed-phase material having a crystalline phase other than the LGPS crystalline phase. In the latter case, the sulfide solid electrolyte in the present disclosure preferably has the LGPS crystalline phase as a main phase. The term “main phase” refers to a crystalline phase to which the peak with the highest diffraction intensity is assigned in the XRD measurement. The proportion of the LGPS crystalline phase to the total crystalline phase contained in the sulfide solid electrolyte is, for example, 50 wt % or more, and may be 70 wt % or more, or 90 wt % or more.

The sulfide solid electrolyte typically contains Li, M, P, and S elements. Examples of the M element include Sb, Si, Ge, Sn, B, Al, Ga, In, Ti, Zr, V, and Nb. The sulfide solid electrolyte may contain one type of M element, or may contain two or more types of M element. The elements contained in the sulfide solid electrolyte can be determined, for example, by subjecting the cathode layer and the pelletized cathode composite material to SEM/EDX analysis.

The composition of the sulfide solid electrolyte is not particularly limited, but may be, for example, a composition represented by Li_{4-α}M_{1-α}P_{α}S₄ (0.55≤α≤0.76). M is the same as the M element described above.

The sulfide solid electrolyte is, for example, in the form of particles. The particle size (D₉₀) of the sulfide solid electrolyte is not particularly limited, but is, for example, 1.6 μm or more, and may be 2.0 μm or more, 2.5 μm or more, 2.6 μm or more, 5.0 μm or more, or 10.0 μm or more. The particle size (D₉₀) of the sulfide solid electrolyte is, for example, 58.0 μm or less, and may be 56.7 μm or less, 55.0 μm or less, 40.0 μm or less, 30.0 μm or less, or 20.0 μm or less. D₉₀ refers to the particle size corresponding to a cumulative frequency of 90% in particle size distribution. D₉₀ may be a value measured by laser diffraction scattering particle size distribution measurement, or may be a value measured by image analysis using software.

The ionic conductivity of the sulfide solid electrolyte at 25° C. is not particularly limited, but is, for example, 3.0 mS/cm or more.

The proportion of the sulfide solid electrolyte in the cathode composite material (solid content) is not particularly limited, but is, for example, 30 wt % or more and 50 wt % or less.

### 3. Cathode Active Material

Examples of the cathode active material in the present disclosure include oxide active materials. Examples of the oxide active materials include rock-salt layered active materials such as LiCoO₂ and LiNi_{1/3}Co_{1/3}Mn_{1/3}O₂, spinel active materials such as LiMn₂O₄, LiNi_{0.5}Mn_{1.5}O₄, and Li₄Ti₅O₁₂, and olivine active materials such as LiFePO₄. The surface of the cathode active material may be coated with a Li ion conductive oxide such as LiNbO₃.

The proportion of the cathode active material in the cathode composite material (solid content) is not particularly limited, but is, for example, 50 wt % or more and 90 wt % or less.

### 4. Cathode Composite Material

The cathode composite material in the present disclosure may contain a conductive material as needed.

Examples of the conductive material include carbon-based conductive materials. Examples of the carbon-based conductive materials include particulate materials such as acetylene black (AB) and Ketjenblack (KB), and fibrous materials such as vapor-grown carbon fibers (VGCFs), carbon nanotubes (CNTs), and carbon nanofibers (CNFs).

The proportion of the conductive material in the cathode composite material (solid content) is not particularly limited, but is, for example, 1 wt % or more and 10 wt % or less.

The cathode composite material may or may not contain a solvent. That is, the cathode composite material may be in the form of a slurry or a powder.

### B. Battery

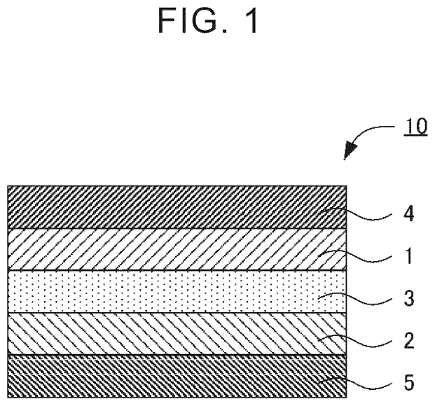

FIG. 1 is a schematic sectional view illustrating a battery according to the present disclosure. A battery 10 shown in FIG. 1 includes a cathode layer 1, an anode layer 2, a solid electrolyte layer 3 disposed between the cathode layer 1 and the anode layer 2, a cathode current collector 4 that collects electrons from the cathode layer 1, and an anode current collector 5 that collects electrons from the anode layer 2. In particular, in the battery 10 of the present disclosure, the cathode layer 1 contains the cathode composite material described above in “A. Cathode Composite Material.”

According to the present disclosure, the cathode layer contains the cathode composite material described above, resulting in a battery with reduced resistance.

### 1. Cathode Layer

The cathode layer contains the cathode composite material described in “A. Cathode Composite Material.” The thickness of the cathode layer is not particularly limited, but is, for example, 30 μm or more and 1000 μm or less.

### 2. Anode Layer

The anode layer contains at least an anode active material, and may further contain at least one of a conductive material, a solid electrolyte, and a binder.

Examples of the conductive material include the conductive materials described in “A. Cathode Composite Material.” The solid electrolyte and the binder may be the materials described in “A. Cathode Composite Material” or may be different materials. Other solid electrolytes include inorganic solid electrolytes such as oxide solid electrolytes, nitride solid electrolytes, halide solid electrolytes, and complex hydrides, and organic solid electrolytes such as polymer electrolytes and gel electrolytes.

The thickness of the anode layer is not particularly limited, but is, for example, 30 μm or more and 1000 μm or less.

### 3. Solid Electrolyte Layer

The solid electrolyte layer is disposed between the cathode layer and the anode layer and contains at least a solid electrolyte. The solid electrolyte layer may contain a binder as needed. The solid electrolyte and the binder are similar to those described in “2. Anode Layer.”

The thickness of the solid electrolyte layer is not particularly limited, but is, for example, 30 μm or more and 1000 μm or less.

### 4. Battery

The battery in the present disclosure typically includes the cathode current collector that collects a current from the cathode layer, and the anode current collector that collects a current from the anode layer. Examples of materials for the cathode current collector include stainless steel (steel use stainless (SUS)), aluminum, nickel, iron, titanium, and carbon. Examples of materials for the anode current collector include SUS, copper, nickel, and carbon.

The battery in the present disclosure may further include a binding jig that applies a binding pressure along a thickness direction to the cathode layer, the solid electrolyte layer, and the anode layer. The binding pressure is, for example, 0.1 MPa or more, and may be 1 MPa or more, or 5 MPa or more. The binding pressure is, for example, 100 MPa or less, and may be 50 MPa or less, or 20 MPa or less.

The battery in the present disclosure is typically a lithium-ion battery. The battery in the present disclosure is typically a solid-state battery because it includes the solid electrolyte layer. The battery in the present disclosure may be a semi-solid-state battery or an all-solid-state battery. The battery containing only the above inorganic solid electrolyte as the solid electrolyte is referred to as “all-solid-state battery.”

The battery in the present disclosure may be a primary battery or a secondary battery, but is preferably the secondary battery. This is because it can be repeatedly charged and discharged and is useful, for example, as an in-vehicle battery. The battery is applied to, for example, a power supply for vehicles such as a hybrid electric vehicle (HEV), a plug-in hybrid electric vehicle (PHEV), a battery electric vehicle (BEV), a gasoline automobile, and a diesel automobile. In particular, the battery is preferably used as a power supply for driving a hybrid electric vehicle (HEV), a plug-in hybrid electric vehicle (PHEV), or a battery electric vehicle (BEV). The battery may also be used as a power supply for mobile bodies other than vehicles (e.g., trains, ships, and aircraft), or as a power supply for electric devices such as information processing devices.

The present disclosure is not limited to the above embodiment. The above embodiment is merely exemplary, and any structure having substantially the same configuration as, and having similar functions and effects to, the technical idea described in the claims of the present disclosure is encompassed by the technical scope of the present disclosure.

### Example 1

### Fabrication of Cathode

An oxide active material (LiNi_{1/3}Co_{1/3}Mn_{1/3}O₂) coated with an oxide solid electrolyte (Li-doped BPO₄: LBPO) was prepared as the cathode active material. A sulfide solid electrolyte (LSnPS) having an LGPS crystalline phase and containing Li, Sn, P, and S elements was prepared. The sulfide solid electrolyte had an average particle size D₉₀ of 1.6 μm. The cathode active material and the sulfide solid electrolyte were weighed out such that the volume ratio was 75:25.

Next, the cathode active material and the sulfide solid electrolyte were mixed with a conductive material (single-walled carbon nanotubes: SWCNT) and a binder (chained PVDF; weight average molecular weight of 1,000,000) in tetralin. Thus, a cathode composite material (cathode slurry) was obtained. The addition amount of the binder was set to 0.6 wt % with respect to the cathode active material.

The cathode composite material was thoroughly dispersed using an ultrasonic homogenizer (UH-50 manufactured by SMT). The cathode composite material was then applied onto a cathode current collector (aluminum foil) and dried at 100° C. for 30 minutes. Then, it was punched out to a size of 1 cm². As a result, a cathode having a cathode layer and a cathode current collector was obtained.

### Fabrication of Anode

A sulfide solid electrolyte (Li₂S—P₂S₅ glass ceramic containing LiI, D₅₀=0.8 μm), 1 wt % of a conductive aid (vapor grown carbon fibers: VGCFs), 2 wt % of a binder (BR binder), and heptane were placed in a kneading vessel of a Filmix apparatus (30-L type manufactured by Primix), and were stirred at 20000 rpm for 30 minutes. Next, an anode active material (Li₄TisO₁₂ particles, D₅₀=1 μm) was placed in the kneading vessel such that the proportion to the solid electrolyte was a volume ratio of 70:30, and the mixture was stirred at 15000 rpm for 60 minutes using the Filmix apparatus. Thus, an anode composite material (anode slurry) was prepared. The anode composite material was applied onto an anode current collector (copper foil) and dried at 100° C. for 30 minutes. Then, it was punched out to a size of 1 cm². As a result, an anode having an anode layer and an anode current collector was obtained.

### Preparation of Solid Electrolyte Layer

In a ceramic tube having a radially inner sectional area of 1 cm², 64.8 mg of a sulfide solid electrolyte (Li₂S—P₂S₅ glass ceramic containing LiI, D₅₀=2.5 μm) was placed and smoothed. Then, it was pressed at 1 ton/cm² to form a solid electrolyte layer.

### Fabrication of Evaluation Battery

The solid electrolyte layer, the cathode, and the anode were stacked such that the cathode layer was disposed on one surface of the solid electrolyte layer and the anode layer was disposed on the other surface, and then pressed at room temperature and 6 ton/cm² for 1 minute. Next, stainless steel rods were placed at the electrodes and bound at 1 ton. As a result, an evaluation battery (all-solid-state lithium-ion battery) was obtained.

### Examples 2 to 5 and Comparative Examples 1 and 2

As shown in Table 1, cathode composite materials and evaluation batteries were fabricated in the same manner as in Example 1, except that the binder and the sulfide solid electrolyte were changed.

### Reference Examples 1 and 2

As the sulfide solid electrolyte, a sulfide solid electrolyte (LPS) containing Li, P, and S elements and not having an LGPS crystalline phase was used. The binder was changed as shown in Table 1. Cathode composite materials and evaluation batteries were fabricated in the same manner as in Example 1, except for these points.

### Evaluation

Each evaluation battery was subjected to constant current-constant voltage charging and discharging at a set voltage of 3.0 V or 1.5 V and a rate of 1/3 C for two cycles. Then, the SOC was adjusted to 40% at a rate of 1/3 C. The battery was discharged at a direct current corresponding to a rate of 2.5 C in a thermostatic chamber maintained at 25° C., and the resistance value was calculated from the voltage drop after 5 seconds with respect to 0 seconds and the applied current. The resistance value of Example 1 was set as the reference value of 1.00, and the battery resistance was evaluated relative to this. The results are shown in Table 1.

TABLE 1

| | Binder | | | | Sulfide solid | | Resistance |
|---|---|---|---|---|---|---|---|
| | | Molecular | | Addition | electrolyte | | value |
| | | weight | | amount | | D₉₀ | (relative |
| | Type | (×10⁴) | Shape | (wt %) | Type | (μm) | value) |
| Example 1 | PVDF | 100 | Chained | 0.6 | LSnPS | 1.6 | 1.00 |
| Example 2 | PVDF | 100 | Chained | 1.0 | LSnPS | 1.6 | 1.17 |
| Example 3 | PVDF | 100 | Chained | 1.4 | LSnPS | 1.6 | 1.20 |
| Example 4 | PVDF | 70 | Chained | 0.6 | LSnPS | 1.6 | 1.04 |
| Example 5 | PVDF | 100 | Chained | 0.6 | LSnPS | 56.7 | 1.28 |
| Comparative | PVDF | 10 | Chained | 0.6 | LSnPS | 1.6 | 1.36 |
| Example 1 | | | | | | | |
| Comparative | SBR | 40 | Spherical | 0.6 | LSnPS | 1.6 | 1.39 |
| Example 2 | | | | | | | |
| Reference | PVDF | 100 | Chained | 0.6 | LPS | 2.6 | 0.90 |
| Example 1 | | | | | | | |
| Reference | SBR | 40 | Spherical | 0.6 | LPS | 2.6 | 0.86 |
| Example 2 | | | | | | | |

As shown in Table 1, Examples 1 to 5 had lower resistance than Comparative Examples 1 and 2. It was confirmed that, when the LGPS sulfide solid electrolyte was used as the sulfide solid electrolyte, the resistance was reduced in the battery according to the present disclosure. In particular, it was confirmed that the resistance values were remarkably low in Examples 1 and 4. Therefore, it was suggested that the weight average molecular weight of the chained fluorine-containing binder was particularly preferably 700,000 or more and 1,000,000 or less, the addition amount of the chained fluorine-containing binder was particularly preferably around 0.6 wt % (0.2 wt % or more and 1.0 wt % or less), and the particle size D₉₀ of the sulfide solid electrolyte was particularly preferably around 1.6 μm (0.5 μm or more and 3.0 μm or less). As shown in Reference Examples 1 and 2, the sulfide solid electrolyte not having an LGPS crystalline phase exhibited a good resistance value. This is presumably because re-agglomeration was less likely to occur in the sulfide solid electrolyte not having an LGPS crystalline phase. It was shown that the increase in battery resistance due to re-agglomeration was an issue specific to the case where the LGPS sulfide solid electrolyte was used.

What is claimed is:

1. A cathode composite material comprising a cathode active material, a sulfide solid electrolyte, and a binder, wherein:
the sulfide solid electrolyte has an LGPS crystalline phase; and
a weight average molecular weight of the binder is 500,000 or more.

2. The cathode composite material according to claim 1, wherein the weight average molecular weight is 1,000,000 or more.

3. The cathode composite material according to claim 1, wherein the weight average molecular weight is 1,500,000 or less.

4. The cathode composite material according to claim 1, wherein a particle size D₉₀ of the sulfide solid electrolyte is 1.6 μm or more and 58.0 μm or less.

5. The cathode composite material according to claim 1, wherein the binder is a chained fluorine-containing binder.

6. A battery comprising a cathode layer, an anode layer, and a solid electrolyte layer disposed between the cathode layer and the anode layer, wherein
the cathode layer contains the cathode composite material according to claim 1.
